(19) United States
(12) Patent Application Publication
(10) Pub. No.: US 2013/0112287 A1
(43) Pub. Date: May 9, 2013

(54) SANITARY FITTING

(71) Applicant: Hansgrone SE, Schittach (DE)

(72) Inventors: Bernd Kronenbitter, Nordrach (DE); Juergen Schorer, Schiltach (DE)

(73) Assignee: HANSGROHE SE, Schiltach (DE)

(21) Appl. No.: 13/658,481

(22) Filed: Oct. 23, 2012

(30) Foreign Application Priority Data
Oct. 27, 2011 (DE) 102011085346.4

(51) Int. Cl. F16K 27/00

(52) U.S. Cl. CPC F16K 27/00
USPC 137/315.01

(57) ABSTRACT

A sanitary fitting includes a socket part configured for fastening the sanitary fitting on a substructure. In axial extension, an accommodation component is connected to this socket part axially and in a rotation-fixed manner, with the accommodation component having an accommodation cavity for a connection base and a valve cartridge. These two components establish the supporting structure of the sanitary fitting. An outer housing is attached to this structure, and said housing can be made from any material, since it does not have a supporting function and does not have any contact with the water. By substituting the socket part, sanitary fittings differing with respect to their size and design may be produced, wherein the accommodation component including valve cartridge, connection base and fastening device for the valve cartridge in the accommodation component are unchanged.

The invention relates to the structure of sanitary fittings.

A sanitary water valve, where to prevent contact to the water led therethrough, the water paths inside the sanitary fitting are provided with a water-tight shielding made of a material free of lead and non-hazardous to health, is already well-known. This allows the creation of a sanitary fitting not posing any health hazard, even with a housing made of a material presenting a potential health hazard (EP 693150).

Furthermore, a single-lever mixer tap is known, where inside the metallic housing of the sanitary fitting an insert including an accommodation cavity for a valve cartridge is provided. Fastening of the sanitary fitting is effected to the housing itself (DE 19756971 A1, DE 19756972 A1).

Furthermore, a sanitary fitting is known including a basic part surrounded by a housing, and inside the basic part an accommodation cavity for a valve cartridge is provided. An adaptor component within the basic part is arranged between the accommodation cavity for the valve cartridge and the connection to the supply lines. In this case, the basic part has a supporting function (EP 1134468 B1).

The object of the invention is to provide a sanitary fitting which, on the one hand, complies with the requirements of health regulations and, on the other hand, may be designed in different shapes and sizes.

The object is achieved by a sanitary fitting presenting the features given in claim 1. Further developments of the invention are the subject-matter of dependent claims. The invention also proposes a set of sanitary fittings which differ from one another due to substitution of individual components.

Thus, the sanitary fitting comprises multiple parts which are adapted to the particular function thereof. The socket part is used to mount the sanitary fittings to a substructure, and thus also to provide for the proper orientation of the sanitary fitting. The accommodation component is mounted on the socket part in axial extension of the latter, with the accommodation component having an accommodation cavity for the valve cartridge and for the connection base, where the supply lines end into. In order to meet health regulations, said accommodation component can be made from a material non-hazardous to health. The housing surrounding these two parts mainly has an aesthetic and decorative character. It does not have a supporting function with regard to the water-conducting components. However, it may be mounted on the socket part and/or the accommodation component in such a way that the overall stability is improved. In particular, a cap part can be attached to the accommodation component in such a way that it significantly contributes to the mechanical stability of the water outlet.

The housing itself may be composed of multiple parts, for example, a body surrounding the fitting and a cap which covers the upper opening of the housing body. Such an opening can be appropriate in order to insert, for example, the socket part, the accommodation component and/or the cartridge. The cap is used to close said opening after insertion.

The connection base of the sanitary fitting is inserted into the accommodation cavity of the accommodation component, until it abuts on a shoulder. Subsequently, the cartridge is slid into the accommodation cavity, until it abuts the connection base. Then, the cartridge is locked or fixed in place, thus also fastening the connection base with a screw nut introduced from the upper side.

In accordance with the invention, the cartridge may be sealed in the area around its upper edge against the fastening nut, wherein, as an additional and/or alternative feature, the fastening nut may also be sealed against the accommodation component.

In a further development of the invention, the accommodation component may be provided with an outlet port radially leading out of the accommodation component, with the outlet port being in communication with the accommodation cavity of the valve cartridge. The outlet port can be used to provide a mixed water outlet from the valve cartridge at another location than through the connection base.

Said outlet port can in particular be used to supply an outlet of the sanitary fitting with water. For this purpose, an outlet element may be arranged in the housing which is connected to the above mentioned outlet port via a tube or any other supply line.

In a further development of the invention, the cap of the housing can be connected to the housing body via a snap-connection. It is also possible to provide an adhesive and/or welded connection and optionally even a hook-and-pile connection.

As an alternative or additional feature, the cap of the housing may also be fastened to the accommodation component by means of a screw nut.

The invention may also provide for the cap to be connected to the accommodation component in a force-fit manner.

Another option provides for the cap to overlap the accommodation component with a flange-like extension.

The cap provides the outlet with strength and stability by the corresponding fastening to the accommodation component.

As already mentioned, the main function of the socket part is to fasten the entire sanitary fitting to a substructure. Therefore, it is appropriate to manufacture the socket part from an accordingly resistant or strong material.

For the accommodation component, that should be made from a non-hazardous material to meet health regulations, an appropriate plastic material can be used according to the invention.

The connection between the socket part and the accommodation component may be designed as a snap-connection and/or a click-lock connection and/or a bayonet connection. The connection has to be locked in axial direction as well as in peripheral direction.

In a preferred configuration, all connections are sealed towards the outside in such a way that in the inside, i.e., between the water-conducting components on the one hand and the housing on the other hand, water cannot collect, and thereby does not give rise to a medium for microbial contamination. Even possible lead-throughs for actuator elements, like outlet valves for example, i.e., external valve actuation devices, are sealed.

The arrangement and the design of the sanitary fitting is determined by the size and the shape of the socket part and the accommodation component, while the outer contour is determined by the housing. Therefore, it is possible to realize different sanitary fittings, i.e., for example, sanitary fittings differing in height or sanitary fittings differing in inclination against the horizontal mounting surface, by merely substituting the socket part. Of course, a different housing has to be used then, but the accommodation component, the valve cartridge and usually also the handle of an actuator element may remain unchanged. Even an outlet element, connected via a tube, can also remain unchanged, since the tube may be exchanged or a corrugated tube of variable length may be used.

Further features, details and advantages of the invention arise from the claims and the summary, the wording of both is incorporated into the content of the description by reference, and the following description of preferred embodiments of the invention as well as the drawing. The drawing shows in:

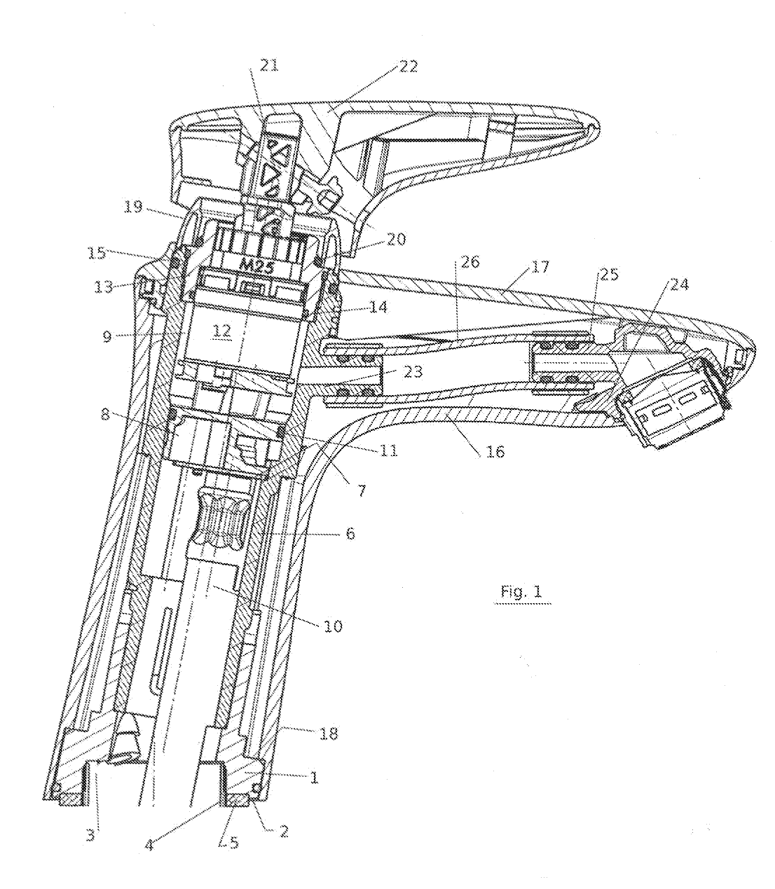

FIG. 1 an axial sectional view of a first embodiment of a sanitary fitting;

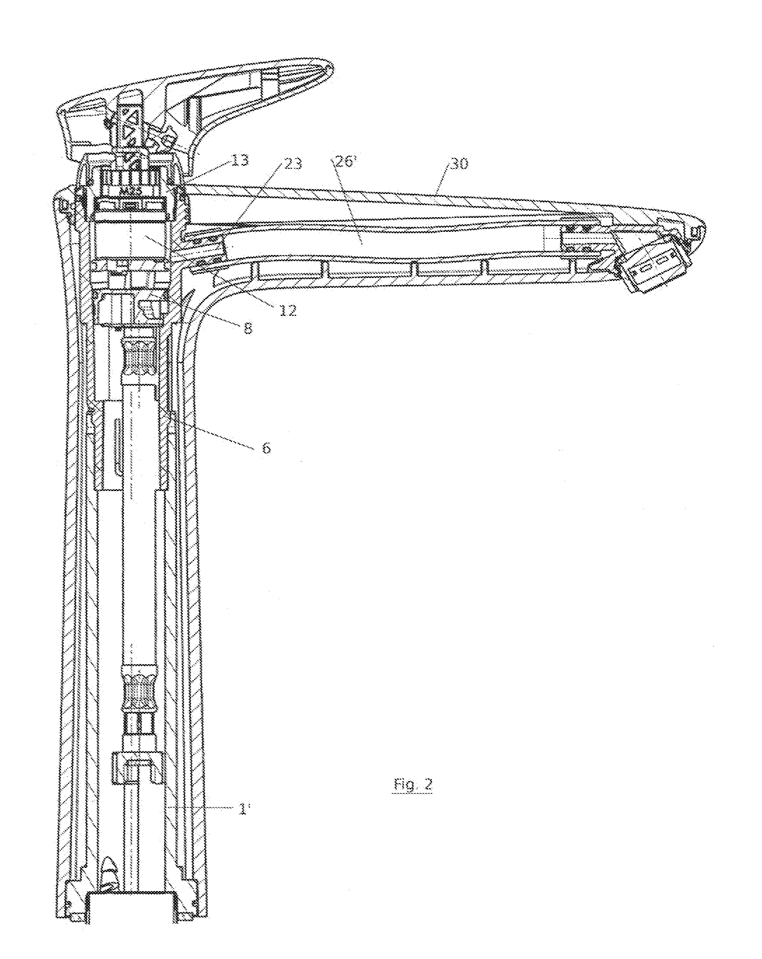

FIG. 2 a sectional view of a second embodiment;

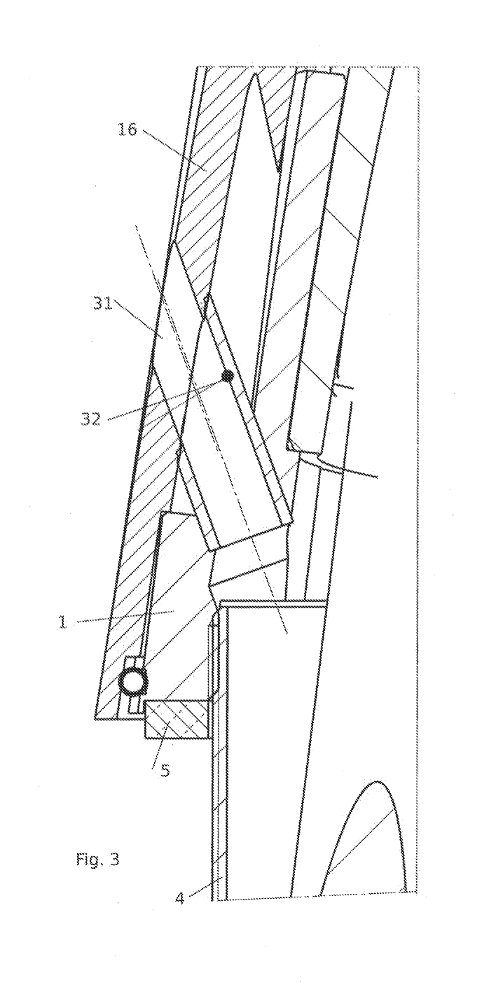

FIG. 3 a partial sectional view through the sanitary fitting according to the invention in enlarged scale.

The sanitary fitting shown in the sectional view of FIG. 1 includes a socket part 1. The bottom side of the socket part 1 has a threaded hole 3, into which, in shadowed view, a threaded sleeve 4 is screwed into, thereby the socket part 1 is fastened to the substructure with its bottom side 2 bearing on a substructure. A sealing ring 5 is inserted in and around the threaded sleeve.

The socket part 1 is extending slightly inclined above its bottom side. Top down, an accommodation component 6 is inserted into the hollow socket part 1, with the accommodation component being secured in both axial and peripheral direction. Said accommodation component extends in the same direction as the socket part. In the interior, at approximately the mid-length of the accommodation component, there is a shoulder 7 with a base 8 bearing on it. Above the shoulder 7, an accommodation cavity 9 is arranged in the accommodation component, in which, as already mentioned, the base 8 is located. The base 8 is used to attach supply lines, designed as supply line tubes 10 in the example shown. The connection base 8 is sealed against the accommodation component 6 with a sealing 11. A valve cartridge 12 is arranged above the connection base 8 in the accommodation cavity 9 and the cartridge bears on the connection base 8. The valve cartridge lies spaced apart from the surrounding walls of the accommodation cavity 9. The cartridge is fixed in the accommodation cavity 9 by means of a fastening nut 13, which is screwed into the outlet orifice of the accommodation cavity 9 from above. A sealing 14 is inserted between the cartridge 12 and the fastening nut 13. The fastening nut is sealed against the accommodation element with a second sealing 15.

A housing is placed over the combination of socket part and accommodation component 6, said housing consisting of a housing body 16 and a housing cap 17. The housing body 16 bears on a shoulder 18 of the socket part 1. The bottom side of the housing body 16 extends flush with the bottom side 2 of the socket part 1.

The housing cap 17 is connected to the housing body 16 alongside its edges via a snap-connection.

For aesthetic reasons, a collar 19 is screwed or snapped onto the fastening nut 13 which is also sealed against the fastening nut by a sealing 20. An actuator shaft 21 projects from the upper side of the valve cartridge and a handle 22 is screw-fastened on the actuator shaft 21.

An outlet port 23 projects from the upper section of the accommodation component 6, and communicating with the accommodation cavity 9.

A discharge insert element 24 is inserted into the housing body and fastened thereto, said insert being an independent component. The discharge insert element 24 has a port 25, directed inwards, with the outer diameter thereof approximately corresponding to the outer diameter of the outlet port 22. The two ports are interconnected via a tube 26.

The housing 16, 17 is connected to the accommodation component 6 in a form-fit manner and completely surrounds the combination of socket part 1 and accommodation component 6, except for the opening covered by the collar 19.

As soon as the water flows out of the supply line 10, the water flowing into the sanitary fitting comes into contact only with the accommodation component 6, naturally also with the valve cartridge 12, the tube 26 and the discharge insert element 24.

Obviously, the sanitary fitting shown in FIG. 2 has a completely different size and a completely different appearance. On the one hand, it is not obliquely mounted on the mounting surface but perpendicularly, and on the other hand it is much taller and also the discharge spout 30 is significantly longer. However, the accommodation component 6 is identical to the one used in the embodiment shown in FIG. 1, also the valve cartridge 12, the fastening nut 13, the collar 9 and the handle 22. Primarily the housing and the socket part 1 were changed.

Thus, by substituting but a few components, a completely different sanitary fitting with regard to size and shape may be obtained.

FIG. 3 shows, in enlarged scale, a possible design of a lead-through for an external valve actuator element. The housing 16 has an oblique aperture 31. In extension of said aperture 31, a tube element 32 made from an elastomer material is inserted. Said tube element 32 is inserted into the housing 16 from below, i.e., through the pipe 4. For this purpose, the tube is compressed or folded, slid into the aperture and then released. Thereby the tube deploys again and takes the position as shown. Thus, this lead-through, which can be used, for example, for a pull rod, is also sealed in a liquid-tight manner.

1. A sanitary fitting, including
a socket part, having a fastening device for fastening the sanitary fitting to a substructure,
an accommodation component which is connectable or connected to the socket part, with the accommodation component having an accommodation cavity for a valve cartridge and a base for connecting the supply lines, and which
is at least partially water-conducting, also including a housing which
completely surrounds the socket part and the accommodation component except for an access for the valve cartridge, and is fastened to the accommodation component and, optionally, to the socket part.

2. A sanitary fitting according to claim 1, wherein the housing is comprised of a body, surrounding the socket part and the accommodation component, and an upper cap which covers the opening in the housing that facilitates the access to at least the accommodation cavity for the valve cartridge.

3. A sanitary fitting according to claim 1, wherein the valve cartridge and the connection base are fastened by a nut screwed into the accommodation cavity of the accommodation component.

4. A sanitary fitting according to claim 3, wherein the valve cartridge is sealed at its upper edge against the fastening nut.

5. A sanitary fitting according to claim 3, wherein the fastening nut is sealed against the accommodation component.

6. A sanitary fitting according to claim 1, wherein the accommodation component has a laterally arranged outlet port in communication with the accommodation cavity for the valve cartridge.

7. A sanitary fitting according to claim 6, including a discharge element arranged in the housing, which is connected to the outlet port of the accommodation component via a duct, in particular a tube.

8. A sanitary fitting according to claim 2, wherein the body of the housing is snapped with the cap.

9. A sanitary fitting according to claim 2, wherein the cap is fastened to the accommodation component by means of a nut.

10. A sanitary fitting according to claim 2, wherein the cap is connected to the accommodation component in a force-fit manner.

11. A sanitary fitting according to claim 2, wherein the cap overlaps the accommodation component with a flange-like extension.

12. A sanitary fitting according to claim 1, wherein the socket part is made from metal and/or the accommodation component is made from plastic.

13. A sanitary fitting according to claim 1, wherein the socket part and the accommodation component are interconnected via a snap-connection and/or a bayonet-connection.

14. A set of sanitary fittings according to claim 1, wherein sanitary fittings can be realized that differ from one another with regard to their shape and/or size by substituting the socket part and the housing and by maintaining the same accommodation component.
